(19) United States
(12) Patent Application Publication
(10) Pub. No.: US 2016/0266051 A1
(43) Pub. Date: Sep. 15, 2016

(54) APPARATUS AND METHOD FOR CALIBRATING SCATTERING DATA OF 3D MICROWAVE IMAGING SYSTEM

(71) Applicant: Electronics and Telecommunications Research Institute, Daejeon (KR)

(72) Inventors: Kwang Jae LEE, Daejeon (KR); Jang Yeol KIM, Daejeon (KR); Laxmikant MINZ, Daejeon (KR); Seong Ho SON, Daejeon (KR); Simonov NIKOLAI, Daejeon (KR); Soon Ik JEON, Daejeon (KR)

(21) Appl. No.: 14/934,824

(22) Filed: Nov. 6, 2015

(30) Foreign Application Priority Data
Mar. 9, 2015 (KR) 10-2015-0032699

(51) Int. Cl. G01N 22/00

(52) U.S. Cl. CPC G01N 22/00

(57) ABSTRACT

Provided is an apparatus and method for calibrating acquired scattering data in a three-dimensional (3D) microwave imaging system. A scattering data calibrating method may include acquiring microwave scattering data for each height of a tank containing a target using a microwave transceiving sensor; and calibrating the microwave scattering data based on a variation between a plurality of sets of microwave scattering data. A height of the tank at which the microwave scattering data is to be acquired may be determined based on a height of the microwave transceiving sensor is located in the tank.

### CROSS-REFERENCE TO RELATED APPLICATION

This application claims priority to and the benefit of Korean Patent Application No. 10-2015-0032699, filed on Mar. 9, 2015, in the Korean Intellectual Property Office, the disclosure of which is incorporated herein by reference.

### BACKGROUND

1. Field of the Invention

Embodiments relate to an apparatus and method for calibrating acquired scattering data in a three-dimensional (3D) microwave imaging system.

2. Description of the Related Art

A three-dimensional (3D) microwave imaging system using microwaves refers to a system that is configured to generate a 3D image of a target using scattering signals acquired by projecting microwaves toward the target. In detail, the 3D microwave imaging system may acquire scattering data including magnitude and phase information of scattered microwaves in such a manner that microwaves emitted from a microwave transceiving sensor are scattered from the target, scattering signals are generated, and another microwave transceiving sensor receives the scattering signals.

A 3D microwave imaging system according to the related art (Meaney et al., Systems and Methods for 3-D Data Acquisition for Microwave Imaging, U.S. patent application Ser. No. 10/407,886, Apr. 4, 2003) discloses an algorithm that may acquire phase information by additionally measuring a plurality of frequency points, and may enhance a resolution of a 3D image of a target by calibrating the acquired phase information.

However, in the 3D microwave imaging system according to the related art, when an operating frequency increases to enhance the resolution of the 3D image of the target, a frequency bandwidth to be measured may become wide and the number of measurement points may also increase. Also, when the target is dense breast tissue in which electric characteristics significantly vary, a narrow frequency measurement distance is required. Thus, the number of measurement points may increase. Accordingly, an amount of time used to measure the target with microwaves to generate the 3D image of the target increases. Also, when a frequency bandwidth to be measured becomes wide, an expensive wideband measurement system may be required.

Accordingly, there is a need for a method that may measure a 3D image of a target within a relatively short period of time using a low-cost narrowband measurement system.

### SUMMARY

Embodiments provide an apparatus and method that may accurately calibration a phase even at a single measurement frequency point regardless of a frequency.

Embodiments also provide an apparatus and method that may measure a three-dimensional (3D) image of a target within a relatively short period of time using a relatively low-cost narrow-band measurement system.

According to an aspect, there is provided a scattering data calibrating method including acquiring microwave scattering data for each height of a tank containing a target using a microwave transceiving sensor, and calibrating the microwave scattering data based on a variation between a plurality of sets of microwave scattering data. A height of the tank at which the microwave scattering data is to be acquired may be determined based on a height of the microwave transceiving sensor being located in the tank.

The calibrating of the microwave scattering data may include setting microwave scattering data measured at a lowest height among the plurality of sets of microwave scattering data as an initial value of the sets of microwave scattering data, calculating the variation between the plurality of sets of microwave scattering data, and determining the calibrated microwave scattering data by sequentially accumulating the variation between the plurality of sets of microwave scattering data to the initial value.

The acquiring of the microwave scattering data may include initializing a height of at least one microwave transceiving sensor to a lower end of the tank, increasing the height of the at least one microwave transceiving sensor, and acquiring the microwave scattering data using the at least one microwave transceiving sensor every time the height of the at least one microwave transceiving sensor increases by a predetermined distance.

The calibrating of the microwave scattering data may include calculating an initial value of the sets of microwave scattering data based on information of a matching medium in which the target is submerged in the tank when a distance between a lowest height among available heights of the microwave transceiving sensor and the target is a distance in which a change by the target is absent in microwave scattering data measured at the lowest height, and determining the calibrated microwave scattering data by sequentially accumulating the variation between the plurality of sets of microwave scattering data to the initial value.

According to another aspect, there is provided a scattering data calibrating method including acquiring microwave scattering data for each azimuth of a tank containing a target using a microwave transceiving sensor, and calibrating the microwave scattering data based on a variation between a plurality of sets of microwave scattering data. An azimuth of the tank at which the microwave scattering data is to be acquired may be determined based on an azimuth of the microwave transceiving sensor being located in the tank.

According to still another aspect, there is provided a scattering data calibrating method including acquiring first microwave scattering data for each height of a tank containing a target using a microwave transceiving sensor installed in the tank, calibrating the first microwave scattering data based on a variation between a plurality of sets of first microwave scattering data, acquiring second microwave scattering data for each azimuth of the tank using the installed microwave transceiving sensor, and removing an error of the calibrated first microwave scattering data by comparing the first microwave scattering data and the second microwave scattering data.

According to yet another aspect, there is provided a scattering data calibrating method including acquiring microwave scattering data of a matching medium that fills in a tank using a microwave transceiving sensor installed in the tank, acquiring first microwave scattering data of a target submerged in the matching medium for each height of the tank using the microwave transceiving sensor, and calibrating the first microwave scattering data of the target based on the microwave scattering data of the matching medium and the first microwave scattering data of the target.

The calibrating of the microwave scattering data of the target may include determining an initial reference matrix of sets of first microwave scattering data of the target based on a variation between a plurality of sets of first microwave scattering data having a lowest frequency among the plurality of sets of frequency-by-frequency first microwave scattering data of the target acquired using microwaves of different frequencies, and sequentially calibrating the frequency-by-frequency first microwave scattering data of the target based on the initial reference matrix.

The sequentially calibrating may include sequentially calibrating the frequency-by-frequency first microwave scattering data of the target, starting from frequency-by-frequency first microwave scattering data corresponding to the lowest frequency, based on a frequency height.

The calibrating of the microwave scattering data may include acquiring first microwave scattering data for each height of the tank using a microwave transceiving sensor corresponding to microwave scattering data of a lowest frequency in microwave scattering data acquired at different locations, removing the error of the calibrated first microwave scattering data by comparing the first microwave scattering data and second microwave scattering data for each azimuth of the tank, and sequentially calibrating the microwave scattering data of the target based on the first microwave scattering data in which the error is removed.

According to still another aspect, there is provided a scattering data calibrating apparatus including a processor configured to acquire microwave scattering data for each height of a tank containing a target using a microwave transceiving sensor, and to calibration the microwave scattering data based on a variation between a plurality of sets of microwave scattering data. A height of the tank at which the microwave scattering data is to be acquired may be determined based on a height of the microwave transceiving sensor being located in the tank.

The processor of the scattering data calibrating apparatus may be further configured to set microwave scattering data measured at a lowest height among the plurality of sets of microwave scattering data as an initial value of the sets of microwave scattering data, to calculate the variation between the plurality of sets of microwave scattering data, and to determine the calibrated microwave scattering data by sequentially accumulating the variation between the plurality of sets of microwave scattering data to the initial value.

The processor of the scattering data calibrating apparatus may be further configured to initialize a height of at least one microwave transceiving sensor to a lower end of the tank, to increase the height of the at least one microwave transceiving sensor, and to acquire the microwave scattering data using the at least one microwave transceiving sensor every time the height of the at least one microwave transceiving sensor increases by a predetermined distance.

The processor of the scattering data calibrating apparatus may be further configured to calculate an initial value of the sets of microwave scattering data based on information of a matching medium in which the target is submerged in the tank when a distance between a lowest height among available heights of the microwave transceiving sensor and the target is a distance in which a change by the target is absent in microwave scattering data measured at the lowest height, and to determine the calibrated microwave scattering data by sequentially accumulating the variation between the plurality of sets of microwave scattering data to the initial value.

According to still another aspect, there is provided a processor configured to acquire microwave scattering data for each azimuth of a tank containing a target using a microwave transceiving sensor, and to calibration the microwave scattering data based on a variation between a plurality of sets of microwave scattering data. An azimuth of the tank at which the microwave scattering data is to be acquired may be determined based on an azimuth of the microwave transceiving sensor being located in the tank.

According to still another aspect, there is provided a scattering data calibrating apparatus including a processor configured to acquire first microwave scattering data for each height of a tank containing a target using a microwave transceiving sensor installed in the tank, to calibration the first microwave scattering data based on a variation between a plurality of sets of first microwave scattering data, to acquire second microwave scattering data for each azimuth of the tank using the installed microwave transceiving sensor, and to remove an error of the calibrated first microwave scattering data by comparing the first microwave scattering data and the second microwave scattering data.

According to still another aspect, there is provided a scattering data calibrating apparatus including a processor configured to acquire microwave scattering data of a matching medium that fills in a tank using a microwave transceiving sensor installed in the tank, to acquire first microwave scattering data of the target submerged in the matching medium for each height of the tank using the microwave transceiving sensor, and to calibration the first microwave scattering data of the target based on the microwave scattering data of the matching medium and the first microwave scattering data of the target.

The processor may be further configured to determine an initial reference matrix of sets of first microwave scattering data of the target based on a variation between a plurality of sets of first microwave scattering data having a lowest frequency among a plurality of sets of frequency-by-frequency first microwave scattering data of the target acquired using microwaves of different frequencies, and to sequentially calibration the frequency-by-frequency first microwave scattering data of the target based on the initial reference matrix.

The processor of the scattering data calibrating apparatus may be further configured to assign a relatively high calibration priority to the frequency-by-frequency first microwave scattering data of the target as a frequency of a microwave corresponding to the frequency-by-frequency first microwave scattering data of the target is lower.

The processor of the scattering data calibrating apparatus may be further configured to acquire first microwave scattering data for each height of the tank using a microwave transceiving sensor corresponding to microwave scattering data of a lowest frequency among a plurality of sets of microwave scattering data acquired at different locations, to remove the error of the calibrated first microwave scattering data by comparing the first microwave scattering data and second microwave scattering data for each azimuth of the tank, and to sequentially calibration the microwave scattering data of the target based on the first microwave scattering data in which the error is removed.

According to embodiments, it is possible to accurately calibration a phase even at a single measurement frequency point regardless of a frequency by calibrating microwave scattering data acquired for each height of a tank based on a variation between a plurality of sets of microwave scattering data acquired for each height of the tank.

Also, according to embodiments, since a phase is calibrated at a single measurement frequency point, there is no need to measure a standard of a low frequency band. Thus, it is possible to measure a 3D image of a target within a relatively short period of time using a relatively low-cost narrowband measurement system.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates a three-dimensional (3D) microwave imaging system according to an embodiment;

FIG. 2 is a top view illustrating a tank of a 3D microwave imaging system according to an embodiment;

FIG. 3 is a block diagram illustrating a scattering data calibrating apparatus according to an embodiment;

FIG. 4 illustrates a scattering data calibrating process according to a first embodiment;

FIG. 5 illustrates an example of calibrated scattering data according to the first embodiment;

FIG. 6 illustrates a scattering data calibrating process according to a second embodiment;

FIG. 7 illustrates an example of calibrated scattering data according to the second embodiment;

FIG. 8 illustrates a scattering data calibrating process according to a third embodiment;

FIG. 9 illustrates a calibrating process based on each height of a tank of FIG. 8;

FIG. 10 illustrates a calibrating process based on each azimuth of the tank of FIG. 8;

FIG. 11 illustrates a scattering data calibrating process according to a fourth embodiment;

FIG. 12 illustrates a scattering data calibrating process according to a fifth embodiment;

FIG. 13 is a flowchart illustrating a scattering data calibrating method according to the first embodiment;

FIG. 14 is a flowchart illustrating a scattering data calibrating method according to the second embodiment;

FIG. 15 is a flowchart illustrating a scattering data calibrating method according to the third embodiment;

FIG. 16 is a flowchart illustrating a scattering data calibrating method according to the fourth embodiment;

FIG. 17 is a flowchart illustrating a process of calibrating microwave scattering data of a target in the scattering data calibrating method according to the fourth embodiment; and

FIG. 18 is a flowchart illustrating a scattering data calibrating method according to the fifth embodiment.

### DETAILED DESCRIPTION

Reference will now be made in detail to embodiments of the present invention, examples of which are illustrated in the accompanying drawings, wherein like reference numerals refer to like elements throughout. Embodiments are described below to explain the present invention by referring to the figures.

Hereinafter, embodiments will be described in detail with reference to the accompanying drawings. A scattering data calibrating method according to embodiments may be performed by a scattering data calibrating apparatus of a scattering data calibrating system.

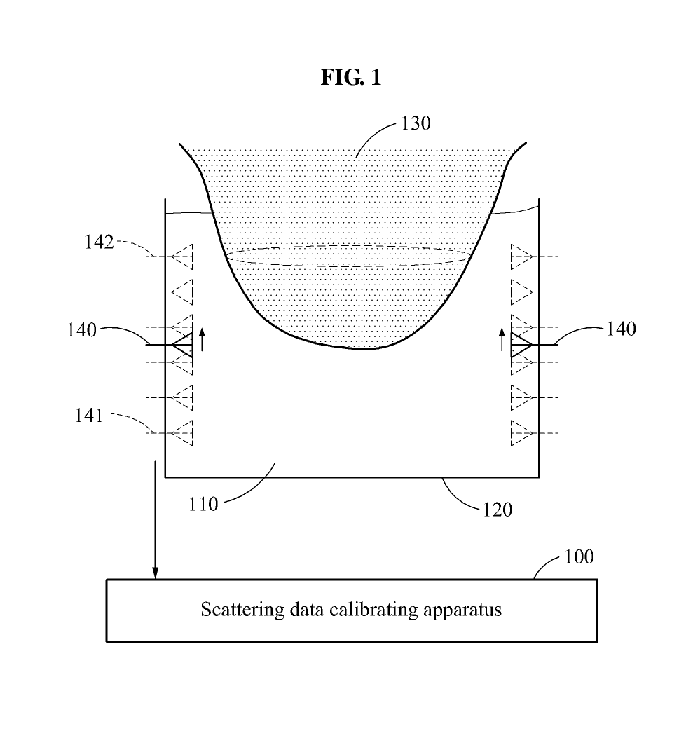

FIG. 1 illustrates a three-dimensional (3D) microwave imaging system according to an embodiment.

Referring to FIG. 1, the 3D microwave imaging system may include a tank 120 filled with a matching medium 110, a microwave transceiving sensor 140 installed in the tank 120, and a scattering data calibrating apparatus 100.

The matching medium 110 is a solution having the same electrical characteristic as an electrical characteristic of a target 130 of which a 3D image is to be measured. Thus, microwaves emitted from the microwave transceiving sensor 140 may be smoothly projected toward the target 130. Also, although the matching medium 110 is a liquid in FIG. 1, the matching medium 110 may be replaced with, for example, a solid dielectric or a gas based on embodiments.

Referring to FIG. 1, the tank 120 is larger than the target 130 and the target 130 may be submerged in the matching medium 110 through an upper portion of the tank 120.

For example, the target 130 may be in a shape similar to a container or a bowl of which an image is approximately predictable, and biological tissue of the target 130 may be similar to fat by a threshold value or more, and may have a simple electrical characteristic.

One or more microwave transceiving sensors 140 may be installed in the tank 120. Each of the microwave transceiving sensors 140 may acquire first microwave scattering data at different heights by moving to an upper end or a lower end of the tank 120. The first microwave scattering data may be microwave scattering data acquired by the scattering data calibrating apparatus 100 through the microwave transceiving sensors 140.

In detail, the microwave transceiving sensor 140 may emit microwaves. Here, the microwaves may be scattered by the target 130 based on a location of the microwave transceiving sensor 140 and thereby be received at another microwave transceiving sensor 140, or may be received at the microwave transceiving sensor 140 disposed at a location opposite to the microwave transceiving sensor 140 without being scattered by the target 130. For example, the scattering data calibrating apparatus 100 may initialize a location of the microwave transceiving sensor 100 to a height 141 that is a movable lowest height of the microwave transceiving sensor 140 in the tank 140. Here, microwaves emitted from the microwave transceiving sensor 140 may be received at the microwave transceiving sensor 140 located on the opposite side of the tank 140 without being scattered by the target 130. The microwave transceiving sensor 140 located on the opposite side of the tank may acquire first microwave scattering data of the height 141.

Further, the microwave transceiving sensor 140 may acquire first microwave scattering data for each height by emitting microwaves at predetermined intervals with increasing the height of the microwave transceiving sensor 140 up to a movable maximum height 142. The predetermined interval may indicate an interval in which a phase variation between the first microwave scattering data acquired by the microwave transceiving sensor 140 at a current location and the first microwave scattering data acquired by the microwave transceiving sensor 140 at a location at which the microwave transceiving sensor 140 has moved by a predetermined distance is less than or equal to ±π.

Here, the scattering data calibrating apparatus 100 may calibration the first microwave scattering data based on a variation between a plurality of sets of first microwave scattering data. Here, the variation between the plurality of sets of first microwave scattering data may be determined based on a change in magnitude and phase information of the first microwave scattering data.

In detail, the scattering data calibrating apparatus 100 may set first microwave scattering data 1 measured at the height 141 as an initial value of the first microwave scattering data.

Also, the scattering data calibrating apparatus 100 may acquire first microwave scattering data 2 measured at a location of a height of the microwave transceiving sensor 140 having moved from the height 141 by the predetermined distance.

The scattering data calibrating apparatus 100 may calibration the first microwave scattering data 2 by accumulating a variation between the first microwave scattering data 2 and the first microwave scattering data 1 to the initial value of the first microwave scattering data.

The scattering data calibrating apparatus 100 may determine calibrated first microwave scattering data for each of heights corresponding to locations of the microwave transceiving sensors 140 being located in the tank 120 by sequentially accumulating a variation between the plurality of sets of first microwave scattering data to the initial value up to first microwave scattering data n acquired at the height 142.

Also, the scattering data calibrating apparatus 100 may acquire a final result of measuring magnitudes of sets of first microwave scattering data by accumulating magnitude information of the sets of first microwave scattering data.

That is, the scattering data calibrating apparatus 100 may calibration microwave scattering data acquired for each height of the tank 120 based on a variation between a plurality of sets of microwave scattering data acquired with respect to the respective heights of the tank 120, and may accurately calibration a phase even at a single measurement frequency point regardless of frequencies. Also, the scattering data calibrating apparatus 100 may have no need to measure a reference of a low frequency band by calibrating a phase at a single measurement frequency point. Accordingly, the scattering data calibrating apparatus 100 may measure a 3D image of the target 130 within a relatively short period of time using a relatively low-cost narrowband measurement system compared to the conventional 3D microwave imaging system.

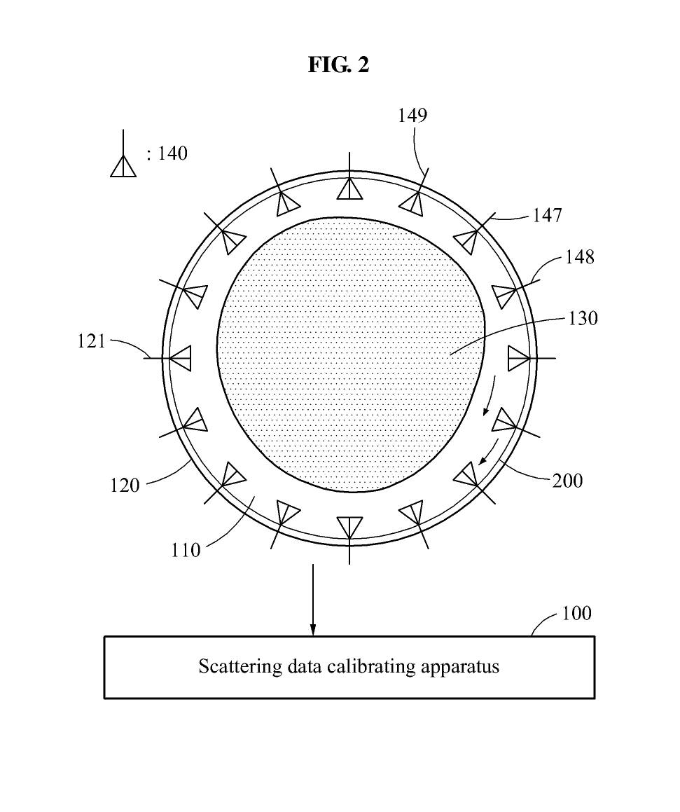

FIG. 2 is a top view illustrating a tank of a 3D microwave imaging system according to an embodiment.

The tank 120 of FIG. 2 is the tank 120 of FIG. 1 shown from the above. For example, the microwave transceiving sensors 140 vertically movable in the tank 120 of FIG. 1 may be configured as a plurality of microwave transceiving sensors 140 installed at different azimuths of the tank 120 of FIG. 2. Here, the microwave transceiving sensors 140 may be installed in the tank 120 to be horizontally rotatable. Such installation structure of the microwave transceiving sensors 140 may vertically move in the tank 120. For example, the microwave transceiving sensors 140 may be installed in a shape of a ring 200.

Further, FIG. 2 may be an embodiment separate from the embodiment of FIG. 1 regarding the 3D microwave imaging system. For example, in FIG. 2, the microwave transceiving sensors 140 may be installed at different azimuths at a preset height of the tank 120. Here, the tank 120 in which the microwave transceiving sensors 140 are installed may be in a horizontally rotatable structure.

The ring 200 or the tank 120 in which the microwave transceiving sensors 140 are installed may rotate in a horizontal direction and may change an azimuth of the target 130 at which each microwave transceiving sensor 140 acquires second microwave scattering data. Here, the second microwave scattering data may refer to microwave scattering data acquired by the scattering data calibrating apparatus 100 through the microwave transceiving sensors 140 located at different azimuths of the tank 120.

In detail, the microwave transceiving sensor 140 may emit microwaves. The microwaves may be scattered by the target 130 of FIG. 2 and be received at one or more other microwave transceiving sensors 140. Here, the scattering data calibrating apparatus 100 may acquire second microwave scattering data of an azimuth at which the microwave transceiving sensor 140 having transmitted the microwaves is located, based on the microwaves received at the one or more other microwave transceiving sensors 140.

In this example, the scattering data calibrating apparatus 100 may acquire second microwave scattering data with respect to the respective azimuths by selecting one of the microwave transceiving sensors 140, by enabling the selected microwave transceiving sensor 140 to emit microwaves, and by enabling the microwave transceiving sensors 140 adjacent to the selected microwave transceiving sensor 140 in a clockwise or counterclockwise direction to sequentially emit microwaves.

Here, an angle between locations of the microwave transceiving sensors 140 based on a center of the tank 120 may be an angle at which a phase variation between second microwave scattering data of the selected microwave transceiving sensor 140 and second microwave scattering data of the microwave transceiving sensor 140 that is adjacent to the selected microwave transceiving sensor 140 in the clockwise or counterclockwise direction is less than or equal to ±π.

Also, when the ring 200 or the tank 120 in which the microwave transceiving sensors 140 are installed rotates in the horizontal direction, the scattering data calibrating apparatus 100 may initialize a location of the ring 200 or the tank 120 to a preset location. The scattering data calibrating apparatus 100 may acquire second microwave scattering data for each azimuth by enabling the microwave transceiving sensors 140 installed in the ring 200 or the tank 120 to emit microwaves at predetermined rotation intervals while clockwise or counterclockwise rotating the ring 200 or the tank 120. Here, the predetermined rotation interval may indicate a rotation interval in which a phase variation between second microwave scattering data acquired by the microwave transceiving sensor 140 at a current location and second microwave scattering data acquired at a location at which the microwave transceiving sensor 140 has rotated by a predetermined distance is less than or equal to ±π.

Here, the scattering data calibrating apparatus 100 may calibration the second microwave scattering data based on a variation between a plurality of sets of second microwave scattering data. Here, the variation between the plurality of sets of second microwave scattering data may be determined based on a change in magnitude and phase information of the second microwave scattering data.

For example, the scattering data calibrating apparatus 100 may set second microwave scattering data 1 of a fifth microwave transceiving sensor 147 having emitted microwaves as an initial value of second microwave scattering data.

The scattering data calibrating apparatus 100 may calibration second microwave scattering data 2 of a sixth microwave transceiving sensor 148 by accumulating a variation between the second microwave scattering data 1 and the second microwave scattering data 2 of the sixth microwave transceiving sensor 148 that is adjacent to the fifth microwave transceiving sensor 147 in a clockwise direction to the initial value of the second microwave scattering data.

The scattering data calibrating apparatus 100 may determine calibrated second microwave scattering data for each of azimuths corresponding to locations of the microwave transceiving sensors 140 being located in the tank 120 by sequentially accumulating a variation between the plurality of sets of second microwave scattering data to the initial value up to a seventh microwave transceiving sensor 149 that is adjacent to the fifth microwave transceiving sensor 147 in a counterclockwise direction.

Also, the scattering data calibrating apparatus 100 may acquire a final result of measuring magnitudes of sets of second microwave scattering data by accumulating magnitude information of the sets of second microwave scattering data.

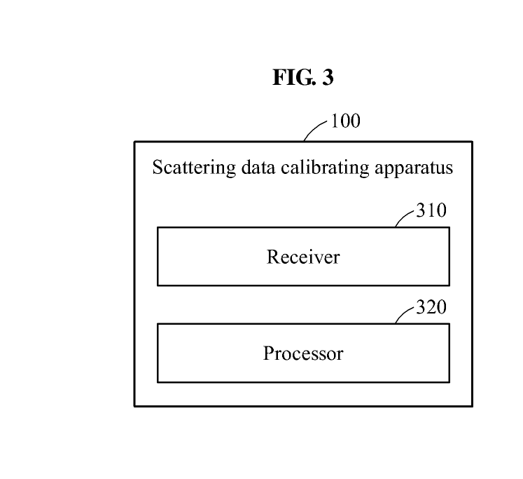

FIG. 3 is a block diagram illustrating a scattering data calibrating apparatus according to an embodiment.

Referring to FIG. 3, the scattering data calibrating apparatus 100 may include a receiver 310 and a processor 320.

The receiver 310 may receive information of microwaves received by microwave transceiving sensors, from the microwave transceiving sensor.

The processor 320 may acquire first microwave scattering data for each height of a tank containing a target. The processor 320 may calibration microwave scattering data based on a variation between a plurality of sets of first microwave scattering data.

Here, the processor 320 may initialize a height of a movable microwave transceiving sensor to a lower end of the tank to acquire first microwave scattering data for each height of the tank. The processor 320 may increase the height of the microwave transceiving sensor. Every time the height of the microwave transceiving sensor increases by a predetermined distance, the processor 320 may acquire first microwave scattering data for each height of the microwave transceiving sensor by enabling the microwave transceiving sensor to emit microwaves.

Also, the processor 320 may set first scattering data measured at a lowest height among the plurality of sets of first microwave scattering data as an initial value of the sets of first microwave scattering data. The processor 320 may calculate a variation between the plurality of sets of first microwave scattering data. The processor 320 may determine calibrated first microwave scattering data by sequentially accumulating the variation between the plurality of sets of first microwave scattering data to the initial value.

When a distance between a lowest height among available heights of the microwave transceiving sensor being located in the tank and the target is a distance in which variation change by the target is absent in scattering data measured at the lowest height, the processor 320 may calculate the initial value of the sets of first microwave scattering data based on information of a matching medium in which the target is submerged in the tank.

The processor 320 may determine calibrated first microwave scattering data by sequentially accumulating the variation between the plurality of sets of first microwave scattering data to the initial value.

Also, the processor 320 may acquire second microwave scattering data for each azimuth of the tank containing the target. The processor 320 may calibration second microwave scattering data based on a variation between a plurality of sets of second microwave scattering data.

The processor 320 may remove an error of the calibrated first microwave scattering data by comparing the first microwave scattering data and the second microwave scattering data.

Also, the processor 320 may acquire microwave scattering data of the matching medium that fills in the tank using the microwave transceiving sensor. Here, the target may not be submerged in the tank.

The processor 320 may acquire microwave scattering data of the target submerged in the matching medium of the tank, using the microwave transceiving sensor.

The processor 320 may calibration the microwave scattering data of the target based on the microwave scattering data of the matching medium and the microwave scattering data of the target.

Here, the processor 320 may acquire microwave scattering data of the target for each frequency (hereinafter, frequency-by-frequency microwave scattering data of the target) by enabling the microwave transceiving sensor to emit microwaves of multiple frequencies.

The processor 320 may determine an initial reference matrix of sets of first microwave scattering data of the target based on a variation between a plurality of sets of first microwave scattering data having a lowest frequency among the plurality of sets of frequency-by-frequency first microwave scattering data of the target. The processor 320 may sequentially calibration the frequency-by-frequency first microwave scattering data of the target based on the initial reference matrix. Here, the processor 320 may assign a relatively high calibration priority to the frequency-by-frequency first microwave scattering data of the target as a frequency of a microwave corresponding to the frequency-by-frequency first microwave scattering data of the target is lower.

Also, the processor 320 may remove an error of first microwave scattering data by comparing the first microwave scattering data and the second microwave scattering data. The processor 320 may sequentially calibration the frequency-by-frequency microwave scattering data of the target, starting from frequency-by-frequency microwave scattering data corresponding to a relatively low frequency, based on the error-removed first microwave scattering data.

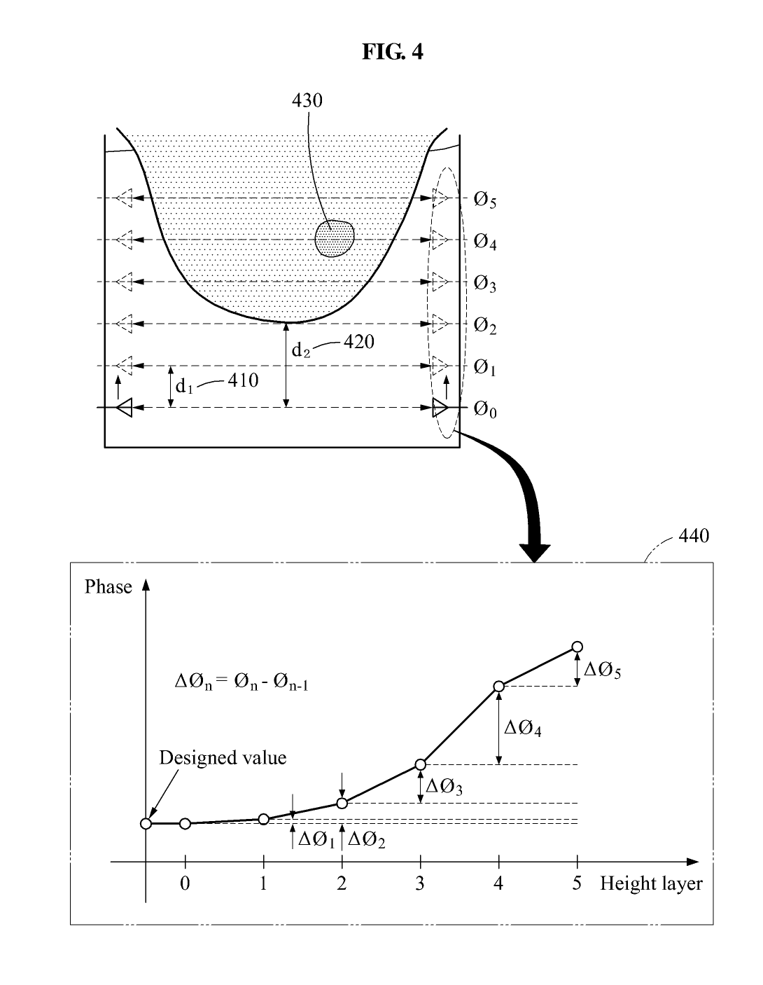

FIG. 4 illustrates a scattering data calibrating process according to a first embodiment.

The first embodiment may represent a process of calibrating first microwave scattering data acquired for each height of a tank using microwave transceiving sensors as illustrated in FIG. 4. In FIG. 4, a height layer may indicate a height at which first microwave scattering data is acquired in the tank.

The scattering data calibrating apparatus 100 may acquire a phase result as shown in a graph 440, based on a plurality of sets of first microwave scattering data measured by emitting, by the microwave transceiving sensors, microwaves while moving toward an upper portion of the tank by a predetermined distance d₁ 410. Here, a target may be submerged in a matching medium at an upper end of the tank and may include a foreign substance 430. For example, the target may be a breast and the foreign substance 430 may be a tumor formed in the breast.

In detail, the scattering data calibrating apparatus 100 may acquire a phase result φ₀ that is first microwave scattering data measured by transmitting, by the microwave transceiving sensor initialized to a lowest height among available heights of the microwave transceiving sensor being located in the tank, microwaves.

The scattering data calibrating apparatus 100 may set the phase result φ₀ as an initial value of first microwave scattering data.

The scattering data calibrating apparatus 100 may acquire a phase result φ₁ that is first microwave scattering data measured by the microwave transceiving sensor having moved toward an upper portion of the tank by a predetermined distance. The scattering data calibrating apparatus 100 may accumulate a variation Δφ₁ that is a difference between the phase result φ₁ and the phase result φ₀ to the initial value φ₀ of first microwave scattering data. Here, the variation Δφₙ may be determined based on the distance d₁ 410, and may be a valid value when the variation Δφₙ has a value within ±π.

In this example, the variation Δφₙ may decrease according to a decrease in the distance d₁ 410. A relationship between the distance d₁ 410 and the variation Δφₙ may be adjusted based on a shape of the target and a frequency used by the microwave transceiving sensor.

The scattering data calibrating apparatus 100 may represent the calibrated first microwave scattering data in a form of a unitary row or column in which elements of the graph 440 are accumulated.

Further, a distance d₂ 420 between the target and the lowest height among available heights of the microwave transceiving sensor being located in the tank may be a distance in which a microwave scattering phenomenon by the target does not affect scattering data measured by a microwave transceiving sensor located at the lowest height. Here, the distance d₂ 420 may be determined based on at least one of a loss characteristic of the matching medium, a distance between microwave transceiving sensors, and a vertical beam width of the microwave transceiving sensor.

Here, the scattering data calibrating apparatus 100 may determine in advance an accurate phase calibration result of the initial value of first microwave scattering data. The scattering data calibrating apparatus 100 may determine the calibrated first microwave scattering data based on the accurate phase calibration result of the initial value. In detail, the scattering data calibrating apparatus 100 may determine the calibrated first microwave scattering data for each height of the tank by sequentially accumulating the variation Δφₙ to the accurate phase calibration result of the initial value.

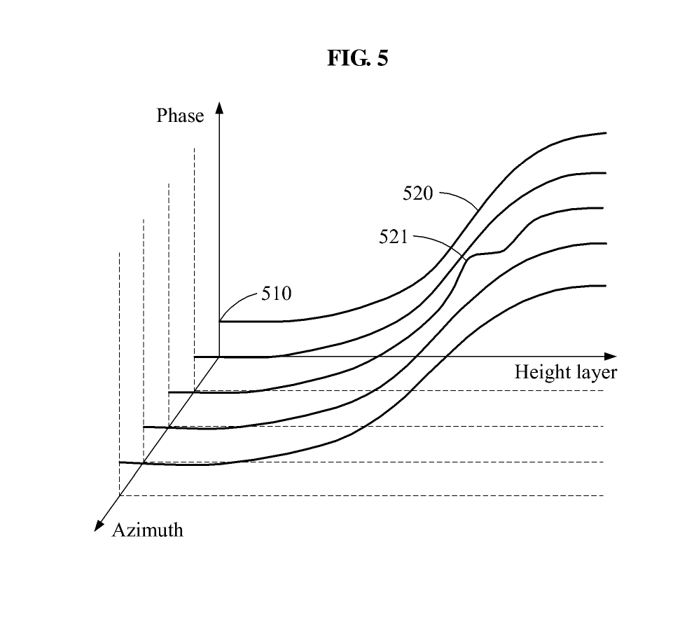

FIG. 5 illustrates an example of calibrated scattering data according to the first embodiment.

Referring to FIG. 5, the scattering data calibrating apparatus 100 according to the first embodiment may independently determine an initial value 510 of first microwave scattering data and calibrated first microwave scattering data 520 with respect to all the azimuths of a tank. In FIG. 5, a height layer may indicate a height at which first microwave scattering data is acquired in the tank.

A phase may vary based on a height of the tank and a change in the phase may be a scattering result of microwaves by a target. Further, an azimuth and a height at which the foreign substance 430 included in the target is located in the tank may be expressed using a curve 521, and may represent scattering data of the foreign substance 430.

Also, when the scattering data calibrating apparatus 100 acquires first microwave scattering data using microwave transceiving sensors moving vertically in the tank, the calibrated first microwave scattering data may be represented as further smooth consecutive values compared to the calibrated first microwave scattering data 520, and a further accurate calibration result may be acquired.

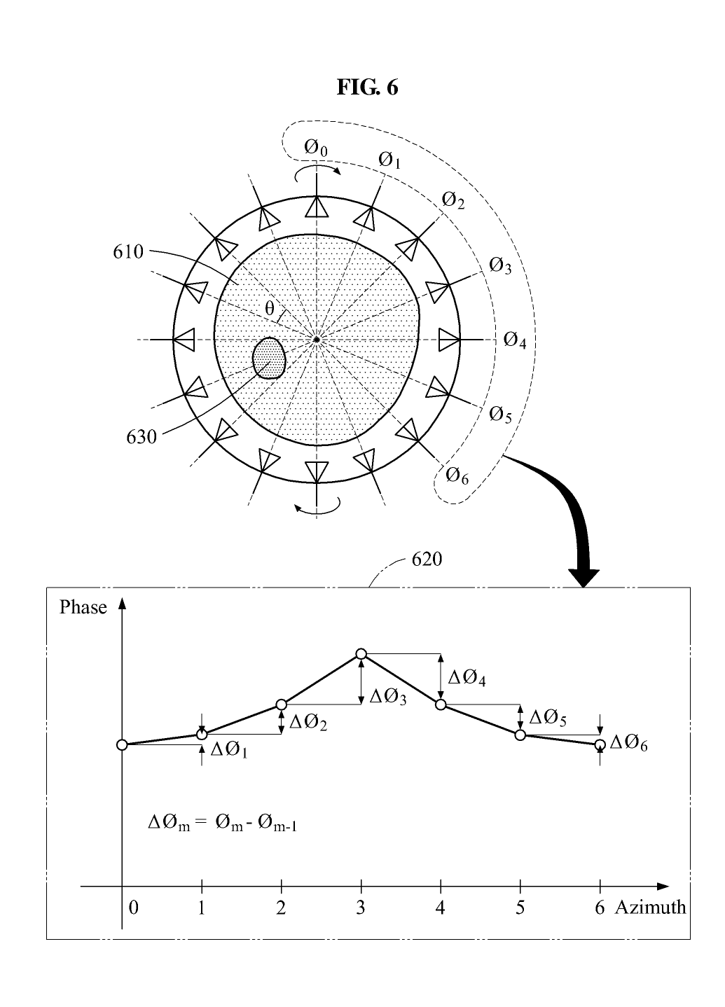

FIG. 6 illustrates a scattering data calibrating process according to a second embodiment.

The second embodiment may represent a process of calibrating second microwave scattering data acquired for each azimuth of a tank using a plurality of microwave transceiving sensors as illustrated in FIG. 6.

The scattering data calibrating apparatus 100 may accumulate a phase result as shown in a graph 620, based on a plurality of sets of second microwave scattering data measured for each azimuth of the tank by microwave transceiving sensors installed in the tank at a predetermined rotation angle θ 610. Here, the target may be submerged in a matching medium at an upper end of the tank and may include a foreign substance 630. For example, the target may be a breast and the foreign substance 630 may be a tumor formed in the breast.

In detail, the scattering data calibrating apparatus 100 may acquire a phase result φ₀ that is second microwave scattering data measured by a microwave transceiving sensor selected from among the microwave transceiving sensors. Here, the scattering data calibrating apparatus 100 may randomly select a single microwave transceiving sensor from among the microwave transceiving sensors.

The scattering data calibrating apparatus 100 may set the phase result φ₀ as an initial value of second microwave scattering data.

The scattering data calibrating apparatus 100 may acquire a phase result φ₁ that is second microwave scattering data measured by a microwave transceiving sensor that is adjacent to the selected microwave transceiving sensor in a clockwise direction. The scattering data calibrating apparatus 100 may accumulate a variation Δφ₁ that is a difference between the phase result φ₁ and the phase result φ₀ to the initial value φ₀ of second microwave scattering data. In this instance, the variation Δφₙ may be determined based on the rotation angle θ 610, and may be a valid value when the variation Δφₙ has a value within ±π.

In this example, the variation Δφₙ may decrease according to a decrease in the rotation angle θ 610. A relationship between the rotation angle θ 610 and the variation Δφₙ may be adjusted based on a shape of the target and a frequency used by the microwave transceiving sensor.

The scattering data calibrating apparatus 100 may represent the calibrated second microwave scattering data in a form of a unitary row or column in which elements of the graph 620 are accumulated.

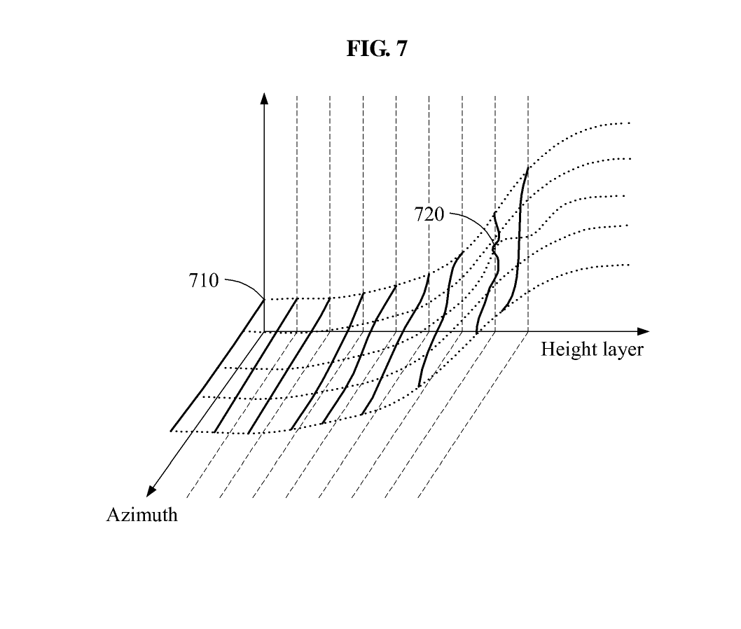

FIG. 7 illustrates an example of calibrated scattering data according to the second embodiment.

Referring to FIG. 7, the scattering data calibrating apparatus 100 according to the second embodiment may determine calibrated second microwave scattering data 710 with respect to all the azimuths of a tank. In FIG. 7, a height layer may indicate a height at which first microwave scattering data is acquired in the tank.

Further, an azimuth and a height at which the foreign substance 630 included in the target is located in the tank may be expressed using a curve 720, and may represent scattering data of the foreign substance 630.

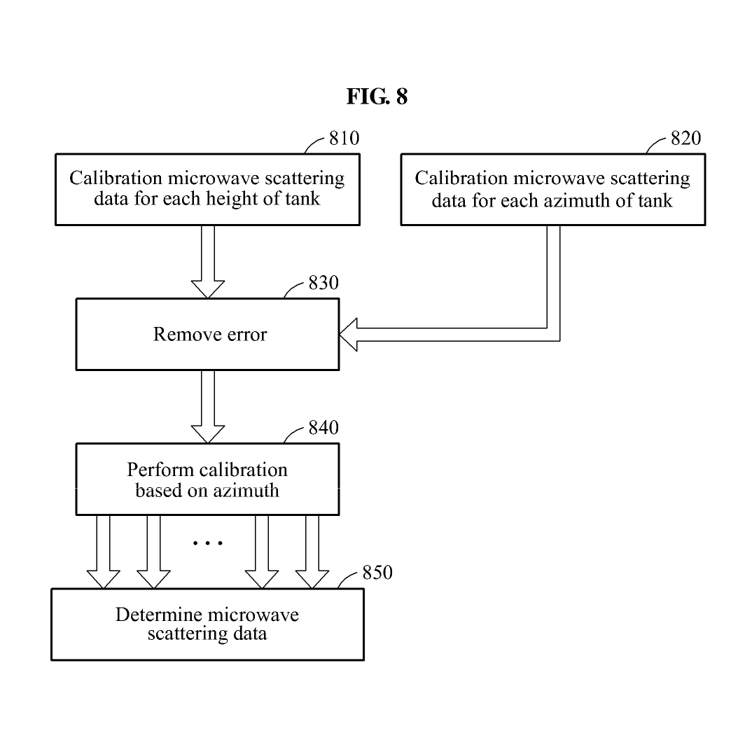

FIG. 8 illustrates a scattering data calibrating process according to a third embodiment.

When accumulating and thereby calibrating first microwave scattering data, a variation between a plurality of sets of first microwave scattering data may exceed a threshold and an accumulative error may occur. Herein, the accumulative error will be referred to as an error for conciseness.

The third embodiment may relate to a method of removing an error occurring when accumulating and calibrating first microwave scattering data, based on second microwave scattering data.

In a process of calibrating first microwave scattering data according to the first embodiment, a phase calibration result may be further accurate according to a decrease in the distance d₁ 410. However, an amount of measurement time used to acquire first microwave scattering data may increase. Accordingly, the distance d₁ 410 may be determined based on the accuracy of the phase calibration result and the amount of measurement time.

However, when the target is in a flat shape or when the target is dense breast tissue, a variation of first microwave scattering data may exceed ±π and thus, an error is likely to occur.

A phase variation of second microwave scattering data measured for each azimuth in the target, for example, a breast in a bowl shape, is less than a variation of first microwave scattering data measured for each height. That is, the second microwave scattering data may be a relatively further accurate measurement result compared to the first microwave scattering data.

Accordingly, the scattering data calibrating apparatus 100 may remove an error occurring when accumulating and calibrating first microwave scattering data, based on second microwave scattering data.

In operation 810, the scattering data calibrating apparatus 100 may calibration first microwave scattering data for each height of a tank. Here, in operation 810, the scattering data calibrating apparatus 100 may calibration the first microwave scattering data according to the first embodiment.

In operation 820, the scattering data calibrating apparatus 100 may calibration second microwave scattering data for each azimuth of the tank. Here, in operation 820, the scattering data calibrating apparatus 100 may calibration the second microwave scattering data according to the second embodiment.

In operation 830, the scattering data calibrating apparatus 100 may remove an error of the first microwave scattering data by comparing the calibrated first microwave scattering data of operation 810 and the calibrated second microwave scattering data of operation 820.

In operation 840, the scattering data calibrating apparatus 100 may calibration the first microwave scattering data with respect to the respective azimuths of the tank. In detail, the scattering data calibrating apparatus 100 may calibration the first microwave scattering data acquired at each of different azimuths of the tank by performing operations 810 through 830 for each azimuth of the tank.

In operation 850, the scattering data calibrating apparatus 100 may determine the calibrated first microwave scattering data as microwave scattering data of the target.

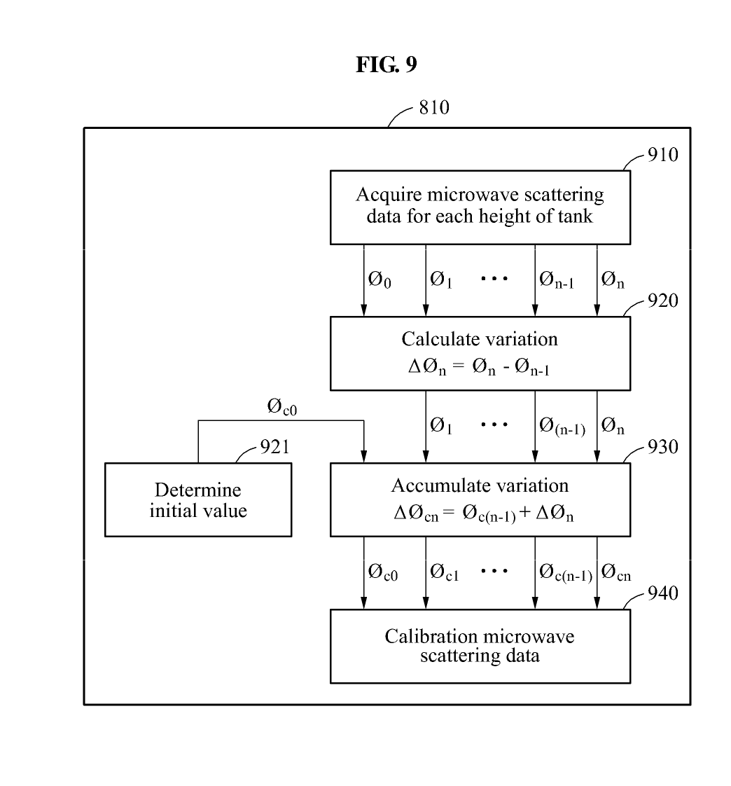

FIG. 9 illustrates a calibrating process based on each height of the tank of FIG. 8. Operations 910 through 940 of FIG. 9 may be included in operation 810 of FIG. 8.

FIG. 9 illustrates a process of calibrating first microwave scattering data according to the first embodiment.

In operation 910, the scattering data calibrating apparatus 100 may acquire first microwave scattering data for each height of a tank. For example, the scattering data calibrating apparatus 100 may acquire the first microwave scattering data, for example, φ₀ through φₙ of FIG. 4.

In operation 920, the scattering data calibrating apparatus 100 may calculate a variation between a plurality of sets of first microwave scattering data acquired in operation 910. For example, the scattering data calibrating apparatus 100 may calculate a variation Δ φₙ between the plurality of sets of first microwave scattering data according to Equation 1.

Δφₙ=φₙ−φₙ₋₁ [Equation 1]

In operation 921, the scattering data calibrating apparatus 100 may set an initial value of first microwave scattering data. For example, when the distance d₂ 420 is a distance in which a microwave scattering phenomenon by the target does not affect scattering data measured by a microwave transceiving sensor installed at a lowest height, the scattering data calibrating apparatus 100 may determine in advance an initial value φ_{c0} of first microwave scattering data based on information of a predesigned matching medium. Also, the scattering data calibrating apparatus 100 may also set φ₀ that is height-based scattering data measured at the lowest height among the plurality of sets of first microwave scattering data obtained in operation 910, as the initial value of the sets of first microwave scattering data.

In operation 930, the scattering data calibrating apparatus 100 may sequentially accumulate the calculated variation between the plurality of sets of first microwave scattering data to the set initial value φ_{c0} of operation 921. For example, the scattering data calibrating apparatus 100 may calculate the accumulated variation Δφ_{cn} according to Equation 2.

Δφ_{cn}=φ_{c(n-1)}+Δφₙ [Equation 2]

In operation 940, the scattering data calibrating apparatus 100 may calibration the acquired first microwave scattering data of operation 910, based on the accumulated variation of operation 930. In detail, the scattering data calibrating apparatus 100 may determine the accumulated variation Δφ_{cn} as the calibrated first microwave scattering data. The scattering data calibrating apparatus 100 may configure and output the calibrated first microwave scattering data in a form of a unitary row or column.

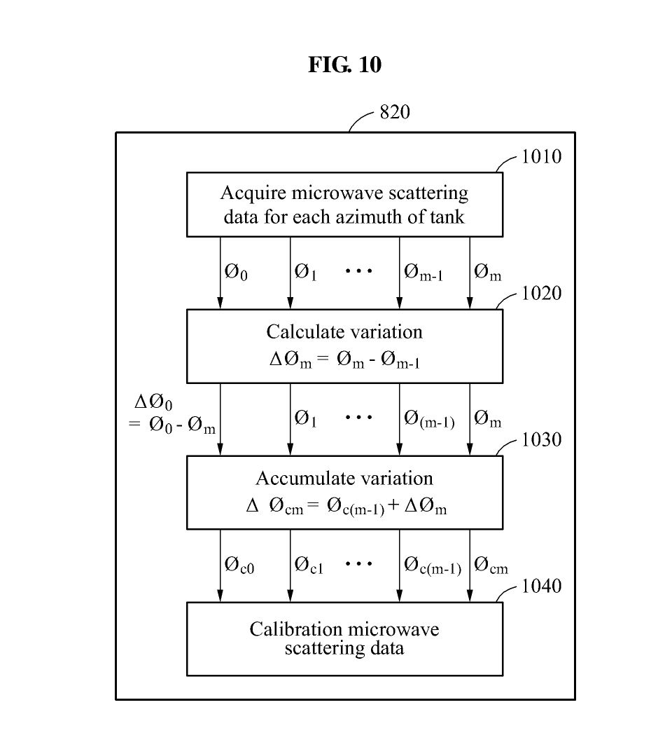

FIG. 10 illustrates a calibrating process based on each azimuth of the tank of FIG. 8. Operations 1010 through 1040 of FIG. 10 may be include in operation 820 of FIG. 8.

FIG. 10 illustrates a process of calibrating second microwave scattering data according to the second embodiment.

In operation 1010, the scattering data calibrating apparatus 100 may acquire second microwave scattering data for each azimuth of a tank. For example, the scattering data calibrating apparatus 100 may acquire second microwave scattering data, for example, φ₀ to φₘ of FIG. 6.

In operation 1020, the scattering data calibrating apparatus 100 may calculate a variation between a plurality of sets of second microwave scattering data acquired in operation 1010. For example, the scattering data calibrating apparatus 100 may calculate a variation Δφₘ between second microwave scattering data according to Equation 3.

Δφₘ=φₘ−φₘ₋₁ [Equation 3]

Here, second microwave scattering data measured by a microwave transceiving sensor that is adjacent to a microwave transceiving sensor having measured φ₀ in a counterclockwise direction may be φₘ. That is, since φ₀₋₁ is equal to φₘ, Δφ₀=φ₀−φₘ.

In operation 1030, the scattering data calibrating apparatus 100 may sequentially accumulate the variation between the plurality of sets of second microwave scattering data calculated in operation 1020. For example, the scattering data calibrating apparatus 100 may calculate the accumulated variation Δφ_{cm} according to Equation 4.

Δφ_{cm}=φc₍ₘ₋₁₎+Δφₘ [Equation 4]

In operation 1040, the scattering data calibrating apparatus 100 may calibration the acquired second microwave scattering data of operation 1010, based on the accumulated variation of operation 1030. In detail, the scattering data calibrating apparatus 100 may determine the accumulated variation Δφ_{cm} as the calibrated second microwave scattering data. The scattering data calibrating apparatus 100 may configure and output the calibrated second microwave scattering data in a form of a unitary row or column.

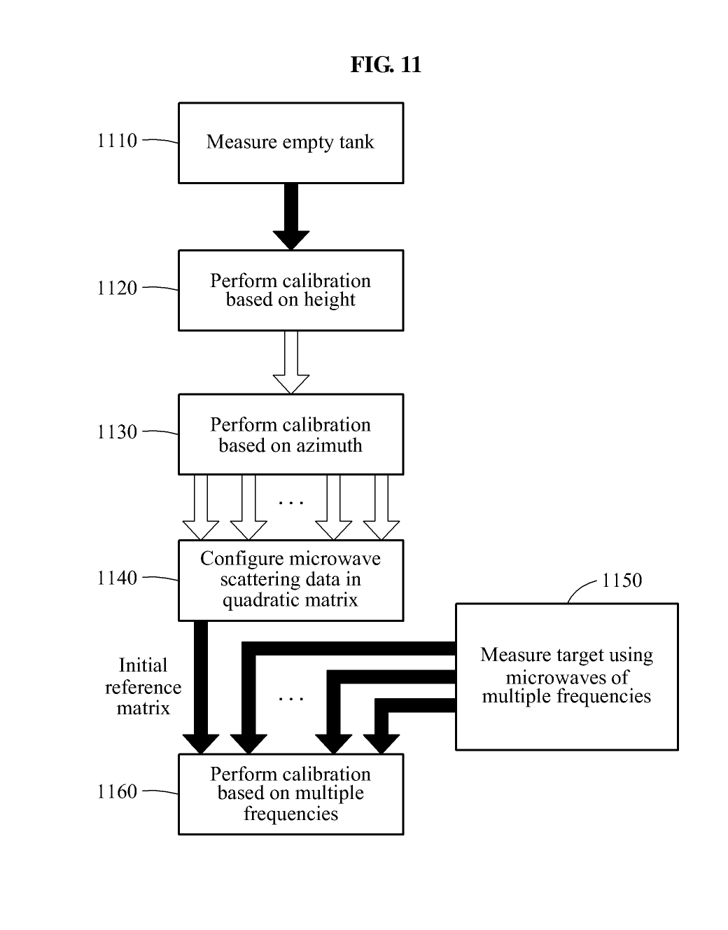

FIG. 11 illustrates a scattering data calibrating process according to a fourth embodiment.

A 3D microwave imaging system may include an environment error according to a change in a state of a microwave scattering data acquiring environment during a microwave scattering data acquiring process. Accordingly, the scattering data calibrating apparatus 100 according to the fourth embodiment may acquire microwave scattering data of a matching medium in which the environment error is removed by acquiring microwave scattering data in a tank before containing a target in the tank. The scattering data calibrating apparatus 100 may further enhance characteristics of microwave scattering data of the target by applying the acquired microwave scattering data of the matching medium to microwave scattering data of the target submerged in the tank.

In operation 1110, the scattering data calibrating apparatus 100 may acquire microwave scattering data of the matching medium in which the environment error is removed by measuring the tank filled with only the matching medium using microwave transceiving sensors before containing the target in the tank. Here, the microwave scattering data of the matching medium in which the environment error is removed may be configured in a form of a quadratic matrix.

In operation 1120, the scattering data calibrating apparatus 100 may acquire microwave scattering data of the target by measuring the target submerged in the tank using the microwave transceiving sensors. Here, microwave scattering data of the target may be microwave scattering data of the target measured using a lowest frequency among frequencies of microwaves that may be emitted from the microwave transceiving sensors. Also, microwave scattering data of the target may be configured in a form of a unitary row or column.

The scattering data calibrating apparatus 100 may calibration the microwave scattering data of the target for each height of the tank according to the tank-height based calibrating process of FIG. 9. Here, the scattering data calibrating apparatus 100 may determine the microwave scattering data of the matching medium acquired in operation 1110 as an initial value of microwave scattering data of the target. The scattering data calibrating apparatus 100 may calibration the microwave scattering data of the target for each height of the tank by sequentially accumulating a variation between a plurality of sets of first microwave scattering data of the target acquired for each height of the tank to the microwave scattering data of the matching medium.

Here, the scattering data calibrating apparatus 100 may calibration an environment error in the microwave scattering data of the target based on a difference between the microwave scattering data of the matching medium in which the environment error is removed and the microwave scattering data of the target.

In operation 1130, the scattering data calibrating apparatus 100 may calibration first microwave scattering data acquired at each of different azimuths of the tank by performing operation 1120 for each azimuth of the tank. Here, the scattering data calibrating apparatus 100 may output microwave scattering data calibrated for each azimuth of the tank, for each azimuth of the tank.

In operation 1140, the scattering data calibrating apparatus 100 may configure the microwave scattering data of the target to be in a form of a quadratic matrix, based on the output microwave scattering data of operation 1130. For example, when the microwave scattering data of the target is in a form of a unitary row, the scattering data calibrating apparatus 100 may set azimuths of the tank as a column. The scattering data calibrating apparatus 100 may configure the microwave scattering data of the target in the form of the quadratic matrix by matching the output microwave scattering data to the azimuths of the tank set as the column.

Here, the scattering data calibrating apparatus 100 may set the microwave scattering data of the target configured in the form of the quadratic matrix as an initial reference matrix of microwave scattering data of the target.

In operation 1150, the scattering data calibrating apparatus 100 may acquire frequency-by-frequency microwave scattering data of the target by measuring the target using microwaves of multiple frequencies output from the microwave transceiving sensors.

The 3D microwave imaging system may generate 3D images that differ based on frequencies of microwaves. Accordingly, the scattering data calibrating apparatus 100 may acquire frequency-by-frequency microwave scattering data of the target corresponding to the frequencies by controlling the microwave transceiving sensors to emit microwaves of different frequencies at predetermined intervals. Here, the frequency-by-frequency microwave scattering data of the target corresponding to the frequencies may be configured in the form of the quadratic matrix.

The scattering data calibrating apparatus 100 may set frequency-by-frequency microwave scattering data of the target corresponding to a lowest frequency among a plurality of sets of frequency-by-frequency microwave scattering data of the target corresponding to the plurality of frequencies, as the initial reference matrix of microwave scattering data of the target. Here, the frequency-by-frequency microwave scattering data of the target selected as the initial reference matrix may be microwave scattering data calibrated through operations 1120 through 1140.

In operation 1160, the scattering data calibrating apparatus 100 may calibration the frequency-by-frequency microwave scattering data of the target acquired operation 1150. Here, the scattering data calibrating apparatus 100 may determine the calibrated frequency-by-frequency first microwave scattering data of the target by accumulating a variation between a plurality of sets of frequency-by-frequency first microwave scattering data of the target to the initial reference matrix.

Here, the scattering data calibrating apparatus 100 may assign a relatively high calibration priority to the frequency-by-frequency first microwave scattering data of the target as a frequency of a microwave corresponding to the frequency-by-frequency first microwave scattering data of the target is lower.

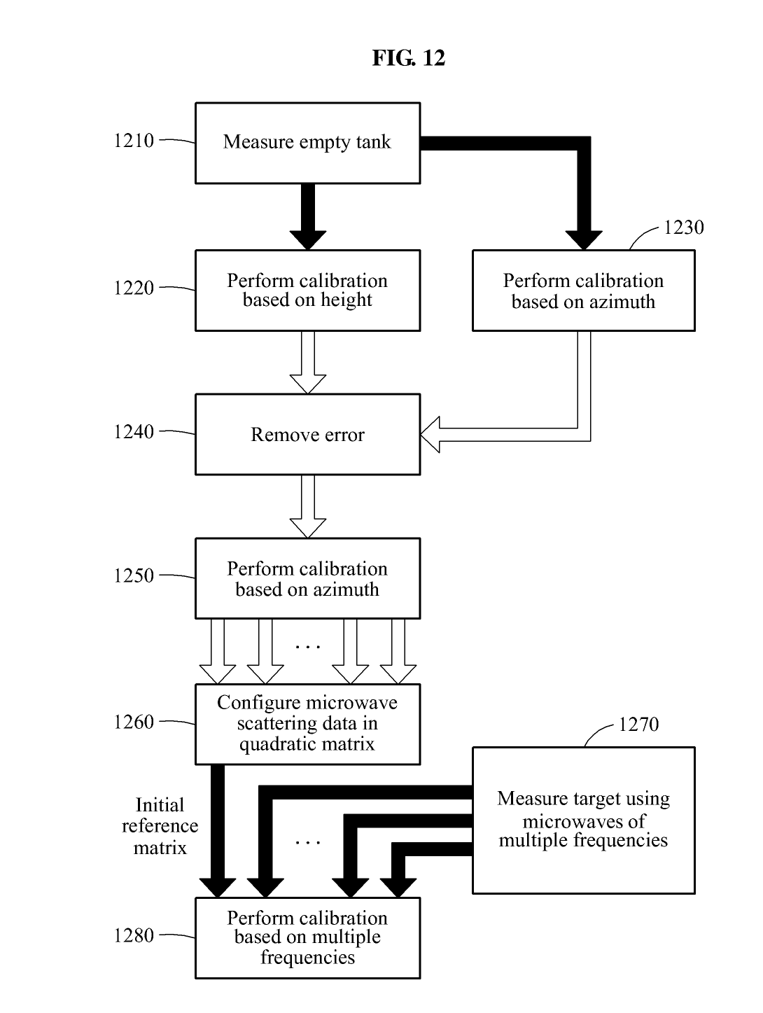

FIG. 12 illustrates a scattering data calibrating process according to a fifth embodiment.

The scattering data calibrating apparatus 100 according to the fifth embodiment may calibration first microwave scattering data of a target based on microwave scattering data of a matching medium and second microwave scattering data of the target.

In operation 1210, the scattering data calibrating apparatus 100 may acquire microwave scattering data of the matching medium in which an environment error is removed by measuring a tank filled with only the matching medium using a microwave transceiving sensor before the target is submerged in the tank. Here, the microwave scattering data of the matching medium in which the environment error is removed may be configured in a form of a quadratic matrix.

In operation 1220, the scattering data calibrating apparatus 100 may acquire first microwave scattering data of the target by measuring the target submerged in the tank using microwave transceiving sensors installed at the respective heights of the tank. Here, the first microwave scattering data of the target may be microwave scattering data of the target measured using a lowest frequency among frequencies of microwaves that may be emitted from the microwave transceiving sensors. Also, the first microwave scattering data of the target may be configured in a form of a unitary row or column.

The scattering data calibrating apparatus 100 may calibration the first microwave scattering data of the target for each height of the tank according to the tank height-based calibrating process of FIG. 9. Here, the scattering data calibrating apparatus 100 may determine the microwave scattering data of the matching medium acquired in operation 1210 as an initial value of first microwave scattering data of the target. The scattering data calibrating apparatus 100 may calibration the first microwave scattering data of the target for each height of the target by sequentially accumulating a variation between a plurality of sets of first microwave scattering data acquired for each height of the tank to the microwave scattering data of the matching medium.

In operation 1230, the scattering data calibrating apparatus 100 may acquire second microwave scattering data of the target by measuring the target submerged in the tank using microwave transceiving sensors installed at the respective azimuths of the tank. Here, the second microwave scattering data of the target may be microwave scattering data of the target measured using a lowest frequency among frequencies of microwaves that may be emitted from the microwave transceiving sensors. Also, the second microwave scattering data of the target may be configured in a form of a unitary row or column.

The scattering data calibrating apparatus 100 may calibration the second microwave scattering data of the target for each azimuth of the tank according to the tank azimuth-based calibrating process of FIG. 10. Here, the scattering data calibrating apparatus 100 may determine microwave scattering data of the matching medium acquired in operation 1210 as an initial value of second microwave scattering data of the target. The scattering data calibrating apparatus 100 may calibration the second microwave scattering data of the target for each azimuth of the tank by sequentially accumulating a variation between a plurality of sets of second microwave scattering data of the target acquired for each azimuth of the tank to the microwave scattering data of the matching medium.

In operation 1240, the scattering data calibrating apparatus 100 may remove an error of first microwave scattering data by comparing the calibrated first microwave scattering data of operation 1220 and the calibrated second microwave scattering data of operation 1230.

In operation 1250, the scattering data calibrating apparatus 100 may remove an error of first microwave scattering data acquired at each of different azimuths of the tank by performing operations 1120 through 1140 for each azimuth of the tank. The scattering data calibrating apparatus 100 may output the error-removed first microwave scattering data for each azimuth of the tank.

In operation 1260, the scattering data calibrating apparatus 100 may configure the first microwave scattering data of the target to be in a form of a quadratic matrix, based on the output first microwave scattering data of operation 1250. For example, when the first microwave scattering data of the target is in a form of a unitary row, the scattering data calibrating apparatus 100 may set azimuths of the tank as a column. The scattering data calibrating apparatus 100 may configure the first microwave scattering data of the target in the form of the quadratic matrix by matching the output first microwave scattering data to the azimuths of the tank set as the column.

Here, the scattering data calibrating apparatus 100 may set the first microwave scattering data of the target configured in the form of the quadratic matrix as an initial reference matrix of the first microwave scattering data of the target.

In operation 1270, the scattering data calibrating apparatus 100 may acquire frequency-by-frequency first microwave scattering data of the target by measuring the target using microwaves of multiple frequencies output from microwave transceiving sensors. Here, the scattering data calibrating apparatus 100 may acquire frequency-by-frequency first microwave scattering data of the target corresponding to the plurality of frequencies by controlling the microwave transceiving sensors to emit microwaves of different frequencies at predetermined intervals. Also, the frequency-by-frequency first microwave scattering data of the target corresponding to the plurality of frequencies may be configured in the form of the quadratic matrix.

The scattering data calibrating apparatus 100 may set frequency-by-frequency first microwave scattering data of the target corresponding to a lowest frequency among a plurality of sets of frequency-by-frequency first microwave scattering data of the target corresponding to the plurality of frequencies, as the initial reference matrix of frequency-by-frequency first microwave scattering data of the target. Here, the frequency-by-frequency first microwave scattering data of the target selected as the initial reference matrix may be microwave scattering data calibrated through operations 1220 through 1260.

In operation 1280, the scattering data calibrating apparatus 100 may calibration the frequency-by-frequency first microwave scattering data of the target acquired in operation 1270. Here, the scattering data calibrating apparatus 100 may determine the calibrated frequency-by-frequency first microwave scattering data of the target by accumulating a variation between a plurality of sets of frequency-by-frequency first microwave scattering data of the target to the initial reference matrix.

Here, the scattering data calibrating apparatus 100 may sequentially calibration the frequency-by-frequency first microwave scattering data of the target, starting from frequency-by-frequency first microwave scattering data of the target corresponding to the lowest frequency, based on a frequency height.

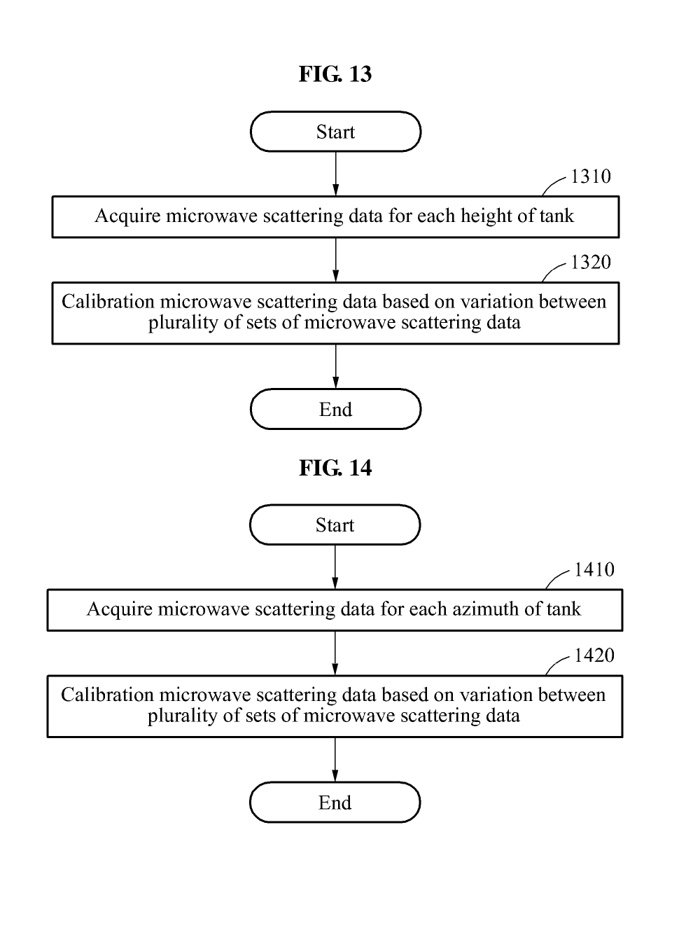

FIG. 13 is a flowchart illustrating a scattering data calibrating method according to the first embodiment.

In operation 1310, the scattering data calibrating apparatus 100 may acquire first microwave scattering data for each height of a tank containing a target using a microwave transceiving sensor. In detail, the scattering data calibrating apparatus 100 may initialize a height of the microwave transceiving sensor being located in the tank to a lowest height at which the microwave transceiving sensor may measure first microwave scattering data, and may emit microwaves at predetermined intervals while moving the microwave transceiving sensor toward an upper end of the tank by a predetermined distance.

In operation 1320, the scattering data calibrating apparatus 100 may calibration the first microwave scattering data based on a variation between a plurality of sets of first microwave scattering data acquired in operation 1310. Here, the scattering data calibrating apparatus 100 may set scattering data measured at the lowest height among the plurality of sets of first microwave scattering data as an initial value of the sets of first microwave scattering data, may calculate a variation between the plurality of sets of first microwave scattering data, and may determine the calibrated first microwave scattering data by sequentially accumulating the calculated variation between the plurality of sets of first microwave scattering data to the initial value.

FIG. 14 is a flowchart illustrating a scattering data calibrating method according to the second embodiment.

In operation 1410, the scattering data calibrating apparatus 100 may acquire second microwave scattering data for each azimuth of a tank containing a target using a microwave transceiving sensor.

When an azimuth of the microwave transceiving sensor is changeable based on the target by rotating the entire ring or tank in which the microwave transceiving sensor is installed, the scattering data calibrating apparatus 100 may measure the target by emitting microwaves at predetermined intervals while clockwise or counterclockwise rotating the ring or the tank in which the microwave transceiving sensor is installed.

In operation 1420, the scattering data calibrating apparatus 100 may calibration second microwave scattering data based on a variation between a plurality of sets of second microwave scattering data acquired in operation 1410. Here, the scattering data calibrating apparatus 100 may calculate the variation between the plurality of sets of second microwave scattering data, and may determine the calibrated second microwave scattering data by sequentially accumulating the variation between the plurality of sets of second microwave scattering data.

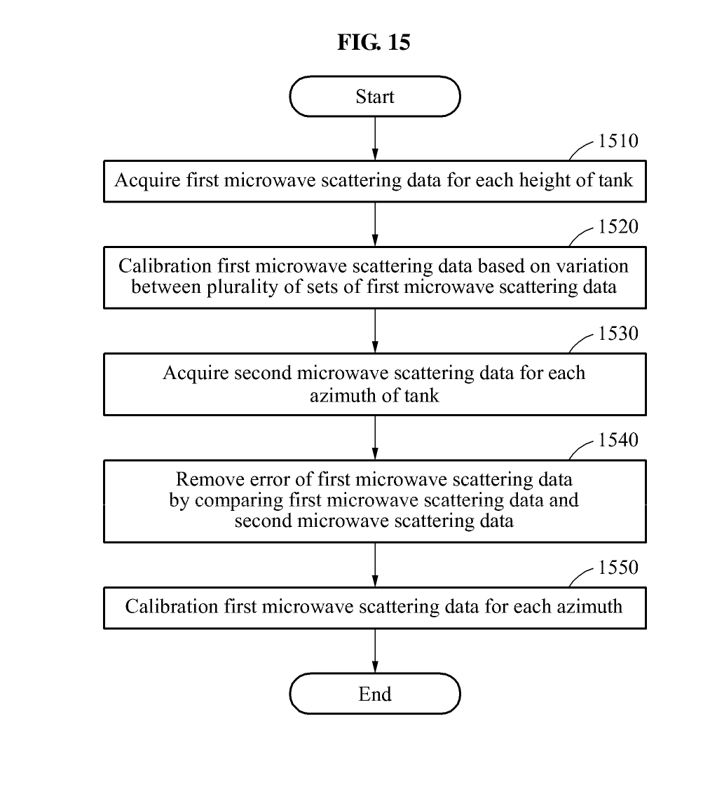

FIG. 15 is a flowchart illustrating a scattering data calibrating method according to the third embodiment.

In operation 1510, the scattering data calibrating apparatus 100 may acquire first microwave scattering data for each height of a tank containing a target, using a microwave transceiving sensor installed in the tank.

In operation 1520, the scattering data calibrating apparatus 100 may calibration the first microwave scattering data based on a variation between a plurality of sets of first microwave scattering data acquired in operation 1510.

In operation 1530, the scattering data calibrating apparatus 100 may acquire second microwave scattering data for each azimuth of the tank using a microwave transceiving sensor installed in the tank.

In operation 1540, the scattering data calibrating apparatus 100 may remove an error of the calibrated first microwave scattering data of operation 1520 by comparing the calibrated first microwave scattering data of operation 1520 and the acquired second microwave scattering data of operation 1530.

In operation 1550, the scattering data calibrating apparatus 100 may calibration the error-removed first microwave scattering data of operation 1540 for each azimuth of the tank. The scattering data calibrating apparatus 100 may determine the calibrated first microwave scattering data as microwave scattering data of the target.

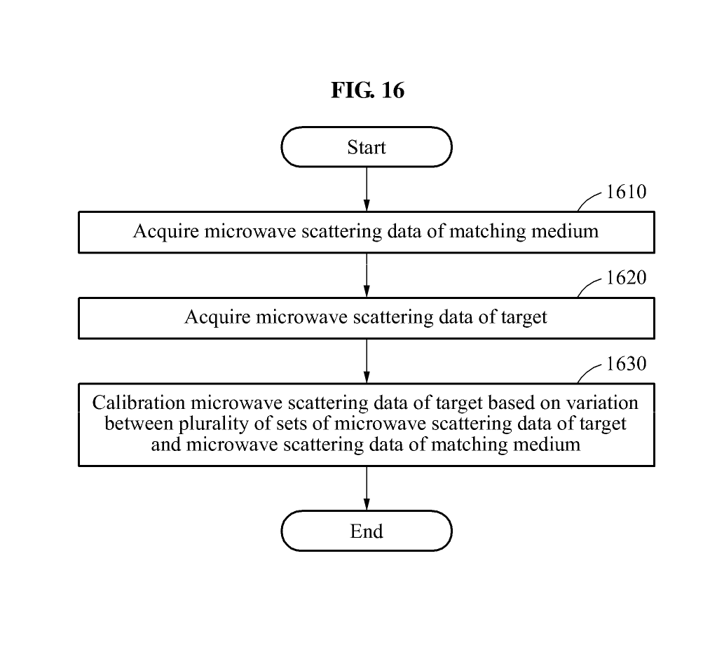

FIG. 16 is a flowchart illustrating a scattering data calibrating method according to the fourth embodiment.

In operation 1610, the scattering data calibrating apparatus 100 may acquire microwave scattering data of a matching medium that fills in a tank using microwave transceiving sensors.

In operation 1620, the scattering data calibrating apparatus 100 may acquire first microwave scattering data of a target submerged in a matching medium of the tank for each height of the tank, using the microwave transceiving sensors. Here, first microwave scattering data of the target may be microwave scattering data of the target measured using a lowest frequency among frequencies of microwaves that may be emitted from the microwave transceiving sensors.

In operation 1630, the scattering data calibrating apparatus 100 may calibration microwave scattering data of the target based on the microwave scattering data of the matching medium acquired in operation 1610 and first microwave scattering data of the target acquired in operation 1620.

In detail, the scattering data calibrating apparatus 100 may set the microwave scattering data of the matching medium acquired in operation 1610 as an initial value of first microwave scattering data of the target. The scattering data calibrating apparatus 100 may determine the calibrated first microwave scattering data of the target by accumulating a variation between a plurality of sets of first microwave scattering data acquired in operation 1620 to the microwave scattering data of the matching medium set as the initial value.

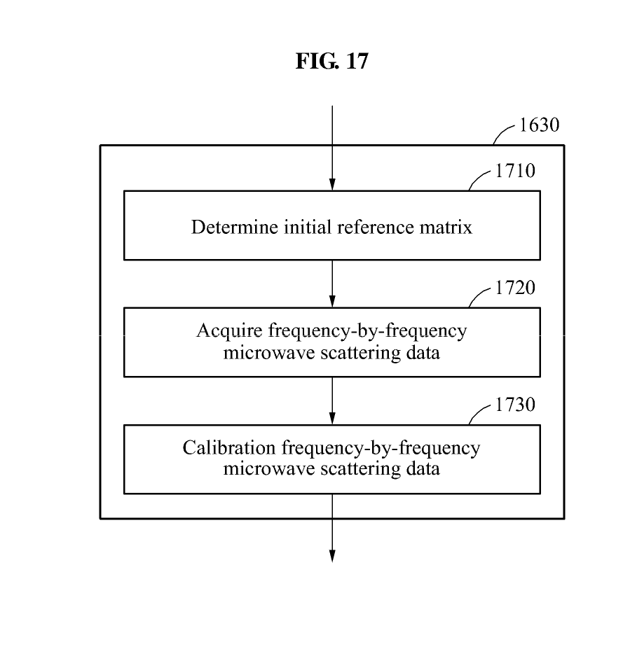

FIG. 17 is a flowchart illustrating a process of calibrating microwave scattering data of a target in the scattering data calibrating method according to the fourth embodiment. Operations 1710 through 1730 of FIG. 17 may be included in operation 1630 of FIG. 16.

FIG. 17 illustrates a process of calibrating microwave scattering data of a target when first microwave scattering data of the target is acquired using the microwave transceiving sensors installed in the tank in operation 1620.

In operation 1710, the scattering data calibrating apparatus 100 may determine an initial reference matrix of first microwave scattering data of the target based on a variation between a plurality of sets of first microwave scattering data corresponding to a lowest frequency among a plurality of sets of first microwave scattering data of the target acquired using microwaves of different frequencies.

In detail, the scattering data calibrating apparatus 100 may set the microwave scattering data of the matching medium acquired in operation 1610 as the initial value of microwave scattering data of the target. The scattering data calibrating apparatus 100 may determine the initial reference matrix of first microwave scattering data of the target by accumulating the variation between the plurality of sets of first microwave scattering data corresponding to the lowest frequency to the microwave scattering data of the matching medium set as the initial value.

In operation 1720, the scattering data calibrating apparatus 100 may acquire frequency-by-frequency microwave scattering data of the target by measuring the target using microwaves of different frequencies. In detail, the scattering data calibrating apparatus 100 may acquire frequency-by-frequency microwave scattering data of the target corresponding to a plurality of frequencies by controlling the microwave transceiving sensors to emit microwaves of different frequencies at predetermined intervals. Here, the frequency-by-frequency microwave scattering data of the target corresponding to the plurality of frequencies may be configured in a form of a quadratic matrix.

In operation 1730, the scattering data calibrating apparatus 100 may sequentially calibration the frequency-by-frequency first microwave scattering data of the target acquired in operation 1720, based on the initial reference matrix determined in operation 1710. Here, the scattering data calibrating apparatus 100 may determine the calibrated frequency-by-frequency first microwave scattering data of the target by accumulating the variation between the plurality of sets of frequency-by-frequency first microwave scattering data of the target to the initial reference matrix.

Here, the scattering data calibrating apparatus 100 may assign a relatively high calibration priority to the frequency-by-frequency first microwave scattering data of the target as a frequency of a microwave corresponding to the frequency-by-frequency first microwave scattering data of the target is lower.

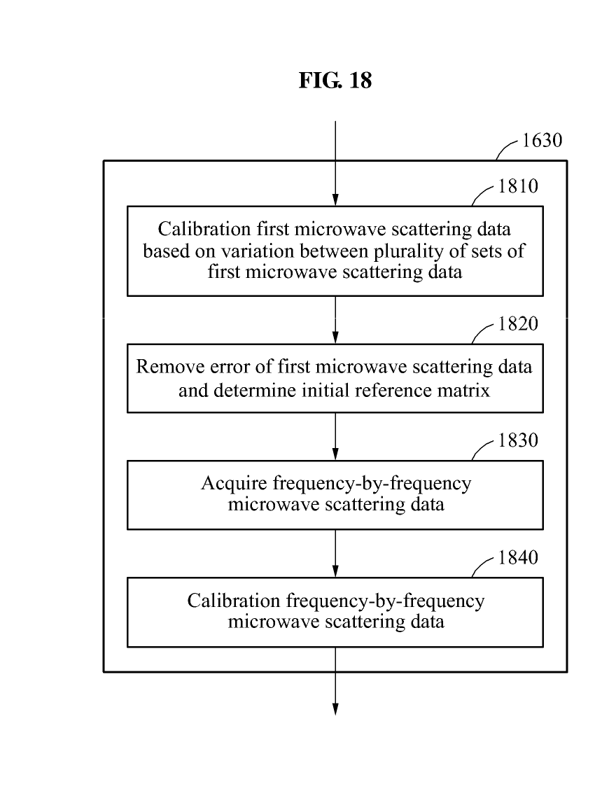

FIG. 18 is a flowchart illustrating a scattering data calibrating method according to the fifth embodiment. Operations 1810 through 1840 of FIG. 18 may be included in operation 1630 of FIG. 16.

FIG. 18 illustrates a process of calibrating microwave scattering data of a target when first microwave scattering data of the target and second microwave scattering data of the target are acquired using microwave transceiving sensors at different heights and azimuths of the tank in operation 1620 of FIG. 16.

In operation 1810, the scattering data calibrating apparatus 100 may calibration the first microwave scattering data of the target based on a variation between a plurality of sets of first microwave scattering data corresponding to a lowest frequency among a plurality of sets of first microwave scattering data of the target acquired using microwaves of different frequencies.

In detail, the scattering data calibrating apparatus 100 may set the microwave scattering data of the matching medium acquired in operation 1610 as an initial value of microwave scattering data of the target. The scattering data calibrating apparatus 100 may determine the calibrated first microwave scattering data of the target by accumulating the variation between the plurality of sets of first microwave scattering data corresponding to the lowest frequency to the microwave scattering data of the matching medium set as the initial value.

In operation 1820, the scattering data calibrating apparatus 100 may remove an error of first microwave scattering data by comparing the calibrated first microwave scattering data of operation 1810 and the acquired second microwave scattering data of operation 1620. Here, the scattering data calibrating apparatus 100 may calibration the second microwave scattering data based on a variation between a plurality of sets of second microwave scattering data, and may remove the error of first microwave scattering data based on the calibrated second microwave scattering data.

Also, the scattering data calibrating apparatus 100 may determine the error-removed first microwave scattering data as an initial reference matrix of first microwave scattering data of the target.

In operation 1830, the scattering data calibrating apparatus 100 may acquire frequency-by-frequency microwave scattering data of the target by measuring the target using microwaves of different frequencies. In detail, the scattering data calibrating apparatus 100 may acquire frequency-by-frequency microwave scattering data of the target corresponding to a plurality of frequencies by controlling the microwave transceiving sensors to emit microwaves of different frequencies at predetermined intervals. Here, the frequency-by-frequency microwave scattering data of the target corresponding to the plurality of frequencies may be configured in a form of a quadratic matrix.

In operation 1840, the scattering data calibrating apparatus 100 may sequentially calibration the frequency-by-frequency first microwave scattering data of the target acquired in operation 1830, based on the initial reference matrix determined in operation 1820. Here, the scattering data calibrating apparatus 100 may determine the calibrated frequency-by-frequency first microwave scattering data of the target by accumulating the variation between the plurality of sets of frequency-by-frequency first microwave scattering data of the target to the initial reference matrix.

Here, the scattering data calibrating apparatus 100 may assign a relatively high calibration priority to the frequency-by-frequency first microwave scattering data of the target as a frequency of a microwave corresponding to the frequency-by-frequency first microwave scattering data of the target is lower.

According to embodiments, it is possible to accurately calibration a phase even at a single measurement frequency point regardless of a frequency by calibrating microwave scattering data acquired for each height of a tank based on a variation between a plurality of sets of microwave scattering data acquired for each height of the tank. Also, according to embodiments, since a phase is calibrated at a single measurement frequency point, there is no need to measure a standard of a low frequency band. Thus, it is possible to measure a 3D image of a target within a relatively short period of time using a relatively low-cost narrowband measurement system.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of calibrating scattering data, the method comprising:
acquiring microwave scattering data for each height of a tank containing a target or for each azimuth of the tank using a microwave transceiving sensor; and
calibrating the microwave scattering data based on a variation between a plurality of sets of microwave scattering data,
wherein a height of the tank at which the microwave scattering data is to be acquired is determined based on a height of the microwave transceiving sensor being located in the tank, and
an azimuth of the tank at which the microwave scattering data is to be acquired is determined based on an azimuth of the microwave transceiving sensor being located in the tank based on the target.

2. The method of claim 1, wherein the calibrating of the microwave scattering data comprises:
setting microwave scattering data measured at a lowest height among the plurality of sets of microwave scattering data as an initial value of the sets of microwave scattering data;
calculating the variation between the plurality of sets of microwave scattering data; and
determining the calibrated microwave scattering data by sequentially accumulating the variation between the plurality of sets of microwave scattering data to the initial value.

3. The method of claim 1, wherein the acquiring of the microwave scattering data comprises:
initializing a height of at least one microwave transceiving sensor to a lower end of the tank;
increasing the height of the at least one microwave transceiving sensor; and
acquiring the microwave scattering data using the at least one microwave transceiving sensor every time the height of the at least one microwave transceiving sensor increases by a predetermined distance.

4. The method of claim 1, wherein the calibrating of the microwave scattering data comprises:
calculating an initial value of the sets of microwave scattering data based on information of a matching medium in which the target is submerged in the tank when a distance between a lowest height among available heights of the microwave transceiving sensor and the target is a distance in which a change by the target is absent in microwave scattering data measured at the lowest height; and
determining the calibrated microwave scattering data by sequentially accumulating the variation between the plurality of sets of microwave scattering data to the initial value.

5. A method of calibrating scattering data, the method comprising:
acquiring first microwave scattering data for each height of a tank containing a target using a microwave transceiving sensor installed in the tank;
calibrating the first microwave scattering data based on a variation between a plurality of sets of first microwave scattering data;
acquiring second microwave scattering data for each azimuth of the tank using the installed microwave transceiving sensor; and
removing an error of the calibrated first microwave scattering data by comparing the first microwave scattering data and the second microwave scattering data.

6. The method of claim 5, further comprising:
acquiring microwave scattering data of a matching medium that fills in the tank using the installed microwave transceiving sensor,
wherein the calibrating of the first microwave scattering data comprises calibrating microwave scattering data of the target based on the microwave scattering data of the matching medium and first microwave scattering data of the target.

7. The method of claim 6, wherein the calibrating of the microwave scattering data of the target comprises:
determining an initial reference matrix of sets of first microwave scattering data of the target based on a variation between a plurality of sets of first microwave scattering data having a lowest frequency among a plurality of sets of frequency-by-frequency first microwave scattering data of the target acquired using microwaves of different frequencies; and
sequentially calibrating the frequency-by-frequency first microwave scattering data of the target based on the initial reference matrix.

8. The method of claim 7, wherein the sequentially calibrating comprises sequentially calibrating the frequency-by-frequency first microwave scattering data of the target, starting from frequency-by-frequency first microwave scattering data corresponding to the lowest frequency, based on a frequency height.

9. The method of claim 6, wherein the calibrating of the microwave scattering data comprises:
acquiring first microwave scattering data for each height of the tank using a microwave transceiving sensor corresponding to microwave scattering data of a lowest frequency among a plurality of sets of microwave scattering data acquired at different locations;
removing the error of the calibrated first microwave scattering data by comparing the first microwave scattering data and second microwave scattering data for each azimuth of the tank; and
sequentially calibrating the microwave scattering data of the target based on the first microwave scattering data in which the error is removed.

10. A scattering data calibrating apparatus comprising:
a processor configured to acquire first microwave scattering data for each height of a tank containing a target using a microwave transceiving sensor installed in the tank, to calibration the first microwave scattering data based on a variation between a plurality of sets of the first microwave scattering data,
to acquire second microwave scattering data for each azimuth of the tank using the installed microwave transceiving sensor, and
to remove an error of the calibrated first microwave scattering data by comparing the first microwave scattering data and the second microwave scattering data.

11. The scattering data calibrating apparatus of claim 10, wherein the processor is further configured
to set first microwave scattering data measured at a lowest height among the plurality of sets of first microwave scattering data as an initial value of the sets of first microwave scattering data,
to calculate the variation between the plurality of sets of first microwave scattering data, and
to calibration the first microwave scattering data by sequentially accumulating the variation between the plurality of sets of first microwave scattering data to the initial value.

12. The scattering data calibrating apparatus of claim 10, wherein the processor is further configured
to initialize a height of at least one microwave transceiving sensor to a lower end of the tank,
to increase the height of the at least one microwave transceiving sensor, and
to acquire the first microwave scattering data using the at least one microwave transceiving sensor every time the height of the at least one microwave transceiving sensor increases by a predetermined distance.

13. The scattering data calibrating apparatus of claim 10, wherein the processor is further configured
to calculate an initial value of the sets of microwave scattering data based on information of a matching medium in which the target is submerged in the tank when a distance between a lowest height among available heights of the microwave transceiving sensor and the target is a distance in which a change by the target is absent in microwave scattering data measured at the lowest height, and
to determine the calibrated first microwave scattering data by sequentially accumulating the variation between the first microwave scattering data to the initial value.

14. The scattering data calibrating apparatus of claim 10, wherein the processor is further configured to acquire microwave scattering data of a matching medium that fills in the tank using the installed microwave transceiving sensor, and to calibration microwave scattering data of the target based on the microwave scattering data of the matching medium and first microwave scattering data of the target.

15. The scattering data calibrating apparatus of claim 14, wherein the processor is further configured to determine an initial reference matrix of sets of first microwave scattering data of the target based on a variation between a plurality of sets of first microwave scattering data having a lowest frequency among a plurality of sets of frequency-by-frequency first microwave scattering data of the target acquired using microwaves of different frequencies, and to sequentially calibration the frequency-by-frequency first microwave scattering data of the target based on the initial reference matrix.

16. The scattering data calibrating apparatus of claim 15, wherein the processor is further configured to sequentially calibration the frequency-by-frequency first microwave scattering data of the target, starting from frequency-by-frequency first microwave scattering data corresponding to the lowest frequency, based on a frequency height.

17. The scattering data calibrating apparatus of claim 14, wherein the processor is further configured
to acquire first microwave scattering data for each height of the tank using a microwave transceiving sensor corresponding to microwave scattering data of a lowest frequency among a plurality of sets of microwave scattering data acquired at different locations,
to remove the error of the calibrated first microwave scattering data by comparing the first microwave scattering data and second microwave scattering data for each azimuth of the tank, and
to sequentially calibration the microwave scattering data of the target based on the first microwave scattering data in which the error is removed.
